(19) United States
(12) Patent Application Publication
(10) Pub. No.: US 2013/0202102 A1
(43) Pub. Date: Aug. 8, 2013

(54) DYNAMIC CALL SPECIAL TREATMENT BASED ON AGGREGATE CALL HOLD QUEUE TIME

(71) Applicants: Peeyush Jaiswal, Boca Raton, FL (US); Aleksas J. Vitenas, Tinton Falls, NJ (US)

(72) Inventors: Peeyush Jaiswal, Boca Raton, FL (US); Aleksas J. Vitenas, Tinton Falls, NJ (US)

(73) Assignee: INTERNATIONAL BUSINESS MACHINES CORPORATION, Armonk, NY (US)

(21) Appl. No.: 13/365,307

(22) Filed: Feb. 3, 2012

(51) Int. Cl. H04M 3/00

(52) U.S. Cl. 379/266.01

(57) ABSTRACT

A computer places in a call queue a call having caller identification information. The computer creates a database record that includes the caller identification information of the call placed in the call queue and an aggregate call queue duration value representing the aggregate time that one or more calls having the caller identification information have been in the call queue. The computer calculates a call queue duration for the call, and adds the calculated call queue duration for the call to the aggregate call queue duration value of the database record associated with the caller identification information of the call. If the aggregate call queue duration value exceeds a predetermined value, the computer provides special treatment to the call.

### FIELD OF THE INVENTION

The present invention relates generally to automatic call distribution systems, and more particularly to applying special treatment to calls on hold that have a high aggregate hold time.

### BACKGROUND

A “call center” includes people, telecommunications equipment and management software, designed to efficiently handle telephonic customer contact. Customers should experience high quality and consistent service as measured, for example, by how long the customer's call must wait in a call queue before being answered and receiving satisfactory service. This service should also be provided to make efficient use of call center resources.

Typically, a call center includes an automatic call distributor (ACD) function in conjunction with a computerized private branch exchange (PBX). The ACD function enables a group of agents to handle a high volume of inbound calls. Modern computer telephone integrated systems typically employ a computer with dedicated voice-communication hardware peripherals. The voice communication peripherals execute the low level processing and switching of the voice channels, under control from the general purpose processor. Therefore, the voice-information is generally not communicated on the computer bus.

When an agent is not available to take a call, the caller is placed in a call queue to await an available agent. Some ACD systems include multiple call queues to allow callers to be routed to a specific agent or group of agents. The ACD function typically routes calls placed in a call queue to an appropriate ACD agent on a first-come-first-served basis, although other routing algorithms can be used. The PBX/ACD monitors the call queue and determines when a call is ready to be transferred to the next available agent. When an agent becomes available, the call is transferred to the agent console along with call related information that may have been gathered by, for example, an interactive voice response unit.

Call queuing plays an important role in call center operations. For example, call queuing can increase agent productivity by minimizing idle time for the agent; allow for simultaneous handling of a greater number of calls during a period of increased calls; and encourage callers to wait for an available attendant as opposed to requiring the caller to call back in response to a busy signal. Call queuing, however, is perceived by customers to be a waste of their time, and may result in frustration, abandoned calls, a loss of business, and poor customer satisfaction when the holding time is deemed excessive.

It is known to reward callers based on hold times during a call. For example, a caller might accrue frequent flyer miles or frequent shopper points the longer a caller is on hold. See, for example, U.S. 2008/0046385 to Dube et al. It is also known to provide various product offers to callers on hold. See, for example, U.S. Pat. No. 7,760,867 to Walker et al. It is also known to offer callers incentives, such as product discounts, account credits, etc., to terminate a call on hold and to, for example, access a specified webpage. See, for example, U.S. 2008/0183570 to Brandt et al.

### SUMMARY

Embodiments of the present invention provide a system, method, and program product to incent a caller to stay on-hold. A computer places in a call queue a call having caller identification information. The computer creates a database record that includes the caller identification information of the call placed in the call queue and an aggregate call queue duration value representing the aggregate time that one or more calls having the caller identification information have been in the call queue. The computer calculates a call queue duration for the call, and adds the calculated call queue duration for the call to the aggregate call queue duration value of the database record associated with the caller identification information of the call. If the aggregate call queue duration value exceeds a predetermined value, the computer provides special treatment to the call.

In certain embodiments, the special treatment includes matching the caller with an agent having a higher than normal skill level, and/or providing a discount on charges for services. In certain embodiments, the step of the computer providing special treatment to the call further includes the computer resetting the aggregate call queue duration value of the database record associated with the caller identification information of the call.

### BRIEF DESCRIPTION OF THE SEVERAL VIEWS OF THE DRAWINGS

FIG. 1 is a functional block diagram of an aggregate wait time dynamic handling system in accordance with an embodiment of the present invention.

FIG. 2 is a flowchart depicting the steps of call center PBX/ACD in accordance with an embodiment of the present invention.

FIG. 3 is a block diagram of hardware and software within the computers of FIG. 1 in accordance with an embodiment of the present invention.

### DETAILED DESCRIPTION

Embodiments of the present invention will now be described in detail with reference to the accompanying drawings.

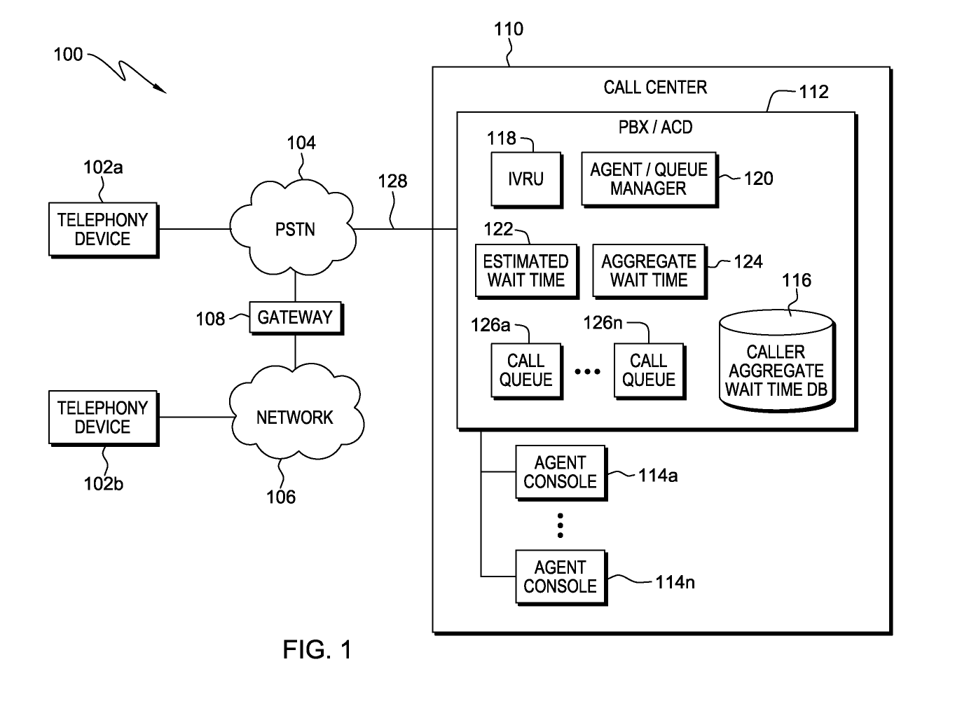

FIG. 1 is a functional block diagram of an aggregate wait time dynamic call handling system 100 in accordance with an embodiment of the present invention. In a preferred embodiment, the aggregate wait time dynamic call handling system 100 includes telephony devices 102a and 102b, the public switched telephone network (PSTN) 104, network 106, gateway 108, and call center 110, which is connected to PSTN 104 via trunk 128.

PSTN 104 represents the world's network of public circuit-switched telephone networks. The network includes, but is not limited to, telephone lines, fiber optic cables, microwave transmission links, cellular networks, communications satellites, and undersea telephone cables, all inter-connected by switching centers, thus allowing any telephone in the world to communicate with any other. Network 106 in conjunction with gateway 108 represents additional access methods to PSTN 104. For example, network 106 can be a cable television network that supports cable telephony and connects to the PSTN via gateway 108. Network 106 can also be the Internet, which supports various internet telephony protocols, and connects to the PSTN via gateway 108. Gateway 108 typically operates as a switch and handles protocol conversion requirements between telephony protocol messages on network 106 and messages on PSTN 104. In certain embodiments, call center 110 can be connected directly to network 106 via a separate trunk, not shown.

Telephony devices 102a and 102b represent devices, typically user or consumer devices, that are used to communicate over PSTN 104. These devices can include, but are not limited to, wireline devices, wireless devices, user computing devices equipped with telephony features, and other devices enabled for network communication. In general, telephony devices 102a and 102b can be any device that supports communications over the PSTN 104 or network 106 in accordance with embodiments of the present invention.

Call center 110 is typically a centralized office used to receive or transmit large volumes of telephone calls to or from agents attending agent consoles. In a preferred embodiment, call center 110 includes PBX/ACD 112, and agent consoles 114a through 114n. In this specification, the terms agent and agent console may be used interchangeably for ease of understanding when not referring specifically to the agent attending the agent console or the agent console itself. In certain embodiments, call center 110 may operate in a distributed manner, with, for example, a centralized PBX/ACD 112 and agent consoles 114 physically located at the agents' homes.

In a preferred embodiment, PBX/ACD 112 operates as a private branch exchange to receive calls from telephony devices 102 via PSTN 104 and trunk 128, and distribute the calls to an appropriate agent attending an agent console 114. Calls received by PBX/ACD 112 include call identification information. In the preferred embodiment, the caller identification information is provided by the automatic number identification (ANI) feature offered by most telecommunications service providers. This feature delivers the billing number of the calling party, usually on a signaling channel of the call connection. In the preferred embodiment, an ACD system is integrated with the private branch exchange function to direct calls to available agents attending agent consoles 114, or to one of the call queues 126 if an agent is not available. PBX/ACD 112 includes the following functional components: IVRU 118, agent/queue manager 120, estimated wait time module 122, aggregate wait time module 124, call queues 126a through 126n, and caller aggregate wait time database 116.

Calls received by PBX/ACD 112 are first directed to interactive voice response unit IVRU 118. IVRU 118 operates to query the caller with one or more questions to assist in determining which agent 114 or group of agents 114 the call is to be directed. After IVRU 118 has collected information from the caller, this information is passed to agent/queue manager 120, which determines to which agent 114 or group of agents 114 the call is to be connected, and either connects the call to the appropriate agent or, if no agent is available to take the call, places the call in a call queue 126. Call queues 126a through 126n represent one or more queues that are associated with one or more agent consoles 114. For example, a group of agents 114 may be assigned to handle a particular set of issues based on the skills of the agents in the group. A call queue 126 will be assigned to the group of agents 114 for calls that are directed to an agent in the group which cannot be immediately answered because an agent in the group is not available. In general, an agent console 114 can be associated with more than one call queue 126. If a call is received by PBX/ACD 112 and agent/queue manager 120 determines that the call should be directed to an agent in the group, then agent/queue manager 120 will attempt to connect the call to one of the agent consoles 114 of the group of agents. If no agent in the group is available to take the call, then agent/queue manager 120 will place the call in the call queue 126 assigned to the group. Calls in the call queue 126 can be connected to agents as they become available, for example, on a first-come-first-served basis.

If an incoming call is placed in a call queue 126 by agent/queue manager 120, estimated wait time module 122 calculates an estimated time in queue for the call based, for example, on the number of calls currently in the queue and the current average hold time for calls in the queue. The calculated estimated time in queue along with ANI caller identification information is passed to aggregate wait time module 124.

Aggregate wait time module 124 operates to update caller aggregate wait time database 116, and to manage special treatment for calls from telephony devices 102 that have accumulated aggregate hold times above a threshold value. When aggregate wait time module 124 receives an estimated time in queue for a call, it queries caller aggregate wait time database 116 to determine if a database record exists that is associated with the ANI caller identification information for the call. If no record exists, aggregate wait time module 124 requests that a database record be created that is associated with the ANI caller identification information for the call. The record includes the ANI caller identification information for the call, and an aggregate wait time value that is set to the estimated time in queue for the call.

In a preferred embodiment, if a caller aggregate wait time database 116 record already exists that is associated with the ANI caller identification information for the call, then aggregate wait time module 124 reads the aggregate wait time value from the database record and adds to it the estimated time in queue for the call. Aggregate wait time module 124 then compares the new aggregate wait time value to a threshold value. If the new aggregate wait time value is more than the threshold value, aggregate wait time module 124 resets the aggregate wait time value in the database record and applies special treatment to the call. The reset value for the aggregate wait time value is typically zero. However, in certain embodiments, the reset value can be greater or less than zero such that special treatment is applied to subsequent calls by the same caller either sooner or later based on aggregate hold time. The special treatment applied to the call can include, for example, giving the call a higher priority in the call queue 126 so that the call will be answered sooner. The special treatment can also include moving the call to another call queue 126 associated with higher skilled agents so that the call might be resolved sooner. The special treatment might also include offering the caller discounts on services or products provided by the company associated with the call center by, for example, connecting the call to IVRU 118, stepping the call through a special menu, and returning the call to its former position in the call queue. If the new aggregate wait time value is less than the threshold value, aggregate wait time module 124 updates the aggregate wait time value in the database record to reflect the new value, and the call is then handled in the default manner.

While only a few examples of special call treatments have been described, those skilled in the art will recognize that numerous additional special call treatments can be envisioned and applied to a call placed in a call queue 126. Similarly, while the exemplary embodiment describes a single threshold value to which the aggregate wait time is compared, in different implementations of the invention, there can be several threshold values. For example, as a caller's aggregate wait time increases, each subsequent call from the caller received by the call center and placed on hold may result in different special treatments. In this case, for example, the aggregate wait time value in the caller's database record would not be reset until the aggregate wait time value exceeds the highest threshold value.

In practice, PBX/ACD 112 is typically implemented as any of several commercially available computer telephony integration systems capable of supporting embodiments of the present invention. These systems typically comprise a computer that includes hardware interfaces to connect to the PSTN 104 and other networks 106, and one or more computer telephony integration (CTI) software packages designed to control interactions between the PSTN 104 and telephone instruments, such as agent consoles 114. The hardware interfaces and CTI software packages support all telephony protocols necessary for one or more embodiments of the present invention. In a preferred embodiment, the CTI software package will support user defined functions and interfaces such that the CTI system will support implementations of embodiments of the current invention.

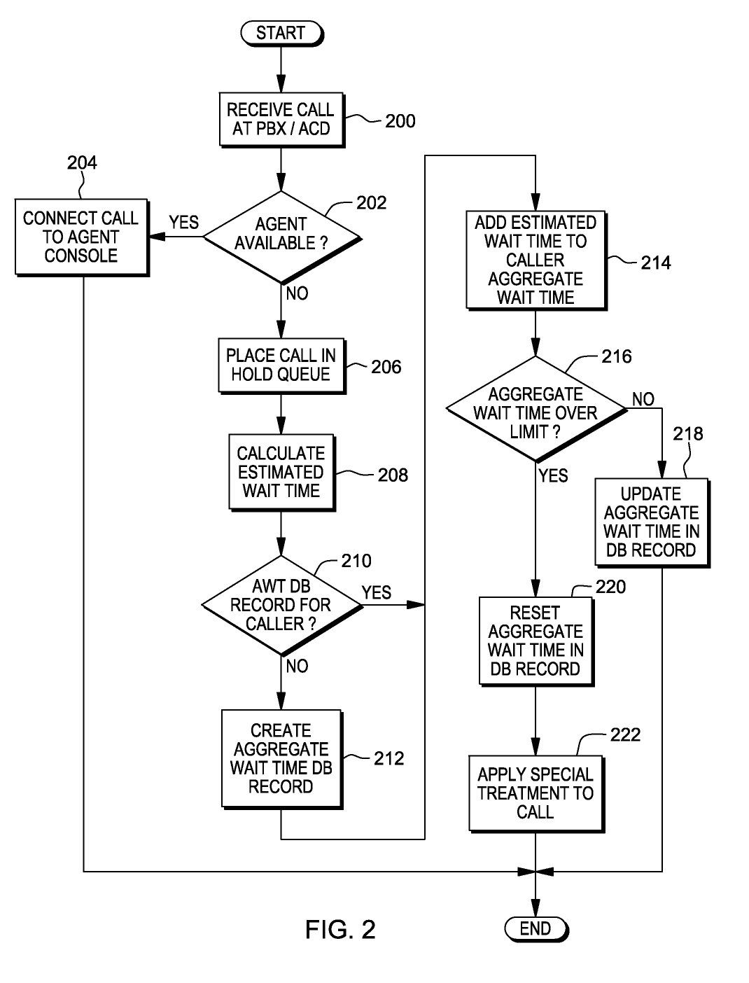

FIG. 2 is a flowchart depicting the steps of PBX/ACD 112 in accordance with an embodiment of the present invention. At step 200, PBX/ACD 112 receives a call from a telephony device 102 via PSTN 104 and trunk 128. The call is first processed by IVRU 118 to determine the nature of the call, and agent/queue manager 120 then determines the appropriate agent 114 or group of agents 114 to which to connect the call. At decision step 202, agent/queue manager 120 determines if an appropriate agent 114 is available. If an appropriate agent console 114 is available, then at step 204, the call is connected to the available agent console 114 and the call processing proceeds in a traditional manner.

If at decision step 202, agent/queue manager 120 determines that an appropriate agent 114 is not available to take the call, then at step 206, agent/queue manager 120 places the call in a call queue 126 associated with the appropriate agent or group of agents 114. At step 208, estimated wait time module 122 calculates an estimated time in queue for the call. At decision step 210, aggregate wait time module 124 determines if a caller aggregate wait time database 116 record exists that is associated with the ANI caller identification information for the call. If aggregate wait time module 124 determines that a database record does not exist that is associated with the ANI caller identification information for the call, then at step 212, aggregate wait time module 124 requests that a database record be created that is associated with the ANI caller identification information for the call, and at step 214, the estimated time in queue is put into the aggregate wait time value of the database record. If at decision step 210 aggregate wait time module 124 determines that a database record does exist that is associated with the ANI caller identification information for the call, then at step 214, aggregate wait time module 124 reads the aggregate wait time value from the database record and adds to it the estimated time in queue.

At decision step 216, aggregate wait time module 124 determines if the new aggregate wait time value is above a predefined threshold value. If the aggregate wait time value in the record is more than the threshold value, then at step 220, aggregate wait time module 124 resets the aggregate wait time value in the database record, and at step 222 applies special treatment to the call. In certain embodiments, there may be a series of increasing threshold values, and the special treatment applied to the call will depend on which of the threshold values the aggregate wait time value in the database record is greater than. If at decision step 216 aggregate wait time module 124 determines that the new aggregate wait time value in the database record is not above a predefined threshold value, then at step 218 aggregate wait time module 124 updates the aggregate wait time value in the database record with the new aggregate wait time value, no special treatment is applied to the call, and the call remains in the call queue 126 in which it was placed, and is connected to the next appropriate agent console in the standard manner.

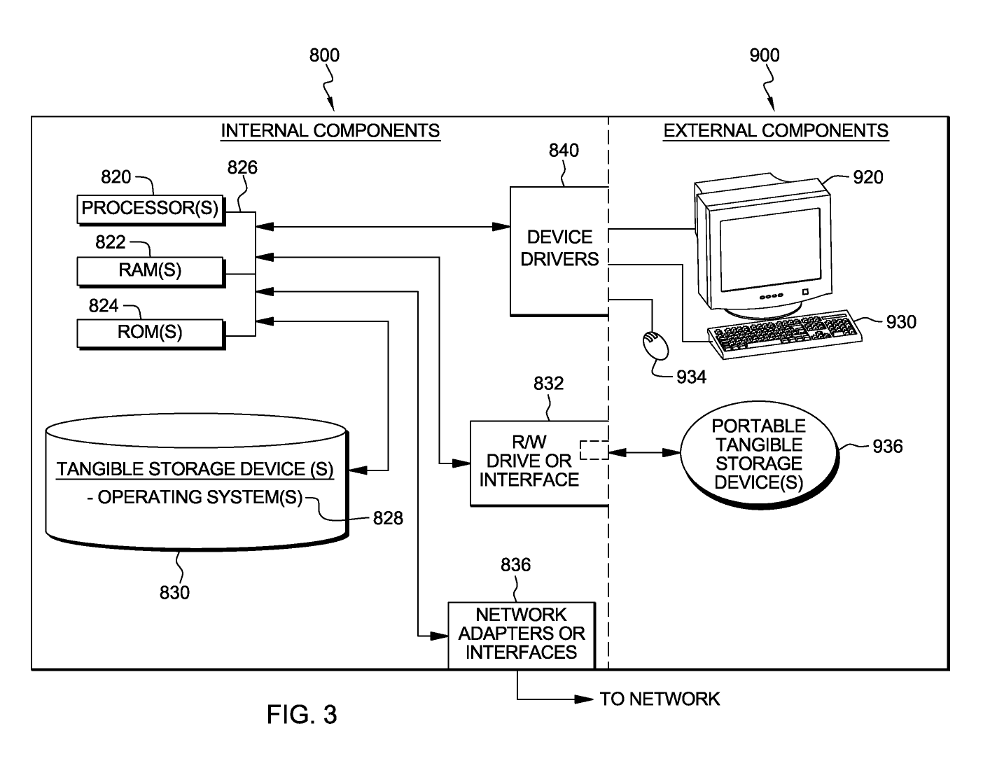

FIG. 3 shows a block diagram of the components of a data processing system 800, 900, such as PBX/ACD 112, in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

PBX/ACD 112 includes internal components 800 and external components 900 as illustrated in FIG. 3. Internal components 800 includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and programs 118, 120, 122 and 124 in PBX/ACD 112 are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Internal components 800 also includes a R/W drive or interface 832 to read from and write to one or more portable computer-readable tangible storage devices 936 such as a CD-ROM, DVD, memory stick, magnetic tape, magnetic disk, optical disk or semiconductor storage device. The programs 118, 120, 122 and 124 in PBX/ACD 112 can be stored on one or more of the respective portable computer-readable tangible storage devices 936, read via the respective R/W drive or interface 832 and loaded into the respective hard drive 830.

Internal components 800 also includes network adapters or interfaces 836 such as a TCP/IP adapter cards, wireless wi-fi interface cards, or 3G or 4G wireless interface cards or other wired or wireless communication links. The programs 118, 120, 122 and 124 in PBX/ACD 112 can be downloaded to PBX/ACD 112 from an external computer via a network (for example, the Internet, a local area network or other, wide area network) and respective network adapters or interfaces 836. From the network adapters or interfaces 836, the programs 118, 120, 122 and 124 in PBX/ACD 112 are loaded into the respective hard drive 830. The network may comprise copper wires, optical fibers, wireless transmission, routers, firewalls, switches, gateway computers and/or edge servers.

External components 900 can include a computer display monitor 920, a keyboard 930, and a computer mouse 934. External components 900 can also include touch screens, virtual keyboards, touch pads, pointing devices, and other human interface devices. Internal components 800 also includes device drivers 840 to interface to computer display monitor 920, keyboard 930 and computer mouse 934. The device drivers 840, R/W drive or interface 832 and network adapters or interfaces 836 comprise hardware and software (stored in tangible storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

Based on the foregoing, computer system, method and program product have been disclosed in accordance with the present invention. However, numerous modifications and substitutions can be made without deviating from the scope of the present invention. Therefore, the present invention has been disclosed by way of example and not limitation.

1. A method for incenting a caller to stay on-hold, the method comprising the steps of:
a computer placing in a call queue a call from a caller;
the computer calculating a call queue duration for the call;
the computer adding the calculated call queue duration for the call to an aggregate call queue duration value in a database record associated with the caller, the aggregate call queue duration value including calculated call queue durations for one or more previous calls from the caller that have been placed in the call queue; and
the computer providing special treatment to the call if the aggregate call queue duration value exceeds a predetermined value.

2. A method in accordance with claim 1, wherein the special treatment comprises one or more of: matching the caller with an agent having a higher than normal skill level; and providing a discount on charges for services.

3. A method in accordance with claim 1, wherein the step of the computer providing special treatment to the call further comprises the computer resetting the aggregate call queue duration value of the database record associated with the caller identification information of the call.

4. A computer program product for incenting a caller to stay on-hold, the computer program product comprising:
one or more computer-readable storage devices and program instructions stored on at least one of the one or more tangible storage devices, the program instructions comprising:
program instructions to place in a call queue a call from a caller;
program instructions to calculate a call queue duration for the call;
program instructions to add the calculated call queue duration for the call to an aggregate call queue duration value in a database record associated with the caller, the aggregate call queue duration value including calculated call queue durations for one or more previous calls from the caller that have been placed in the call queue; and
program instructions to provide special treatment to the call if the aggregate call queue duration value exceeds a predetermined value.

5. A computer program product in accordance with claim 4, wherein the special treatment comprises one or more of: program instructions to match the caller with an agent having a higher than normal skill level; and program instructions to provide a discount on charges for services.

6. A computer program product in accordance with claim 4, wherein the program instructions to provide special treatment to the call further comprise program instructions to reset the aggregate call queue duration value of the database record associated with the caller identification information of the call.

7. A computer system to incent a caller to stay on-hold, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to place in a call queue a call having caller identification information;
program instructions to calculate a call queue duration for the call;
program instructions to add the calculated call queue duration for the call to an aggregate call queue duration value in a database record associated with the caller, the aggregate call queue duration value including calculated call queue durations for one or more previous calls from the caller that have been placed in the call queue; and
program instructions to provide special treatment to the call if the aggregate call queue duration value exceeds a predetermined value.

8. A computer system in accordance with claim 7, wherein the special treatment comprises one or more of: program instructions to match the caller with an agent having a higher than normal skill level; and program instructions to provide a discount on charges for services.

9. A computer system in accordance with claim 7, wherein the program instructions to provide special treatment to the call further comprise program instructions to reset the aggregate call queue duration value of the database record associated with the caller identification information of the call.
